(19) United States
(12) Patent Application Publication
(10) Pub. No.: US 2024/0378911 A1
(43) Pub. Date: Nov. 14, 2024

(54) TERRAIN-AWARE OBJECT DETECTION FOR VEHICLE APPLICATIONS

(71) Applicant: QUALCOMM Incorporated, San Diego, CA (US)

(72) Inventors: Balaji Shankar Balachandran, San Diego, CA (US); Varun Ravi Kumar, San Diego, CA (US); Senthil Kumar Yogamani, Headford (IE)

(21) Appl. No.: 18/314,579

(22) Filed: May 9, 2023

(51) Int. Cl. G06V 20/70; B60W 50/00; G06N 3/09; G06V 10/774; G06V 10/80; G06V 20/58

(52) U.S. Cl. CPC G06V 20/70; B60W 50/00; G06N 3/09; G06V 10/774; G06V 10/806; G06V 20/58; B60W 2050/0019; B60W 2554/00

(57) ABSTRACT

This disclosure provides systems, methods, and devices for vehicle driving assistance systems that support image processing. In a first aspect, a method is provided to train a machine learning model using image data and position data to identify contact points and ground surface normal vectors. Image data is received that depicts an object, and position data for the object is also received, such as point cloud position information for various points along the object's exterior surface. Two sets of labels may then be determined based on the position data, with one set identifying where the object contacts a ground surface and another identifying at least one normal vector for the ground surface. The machine learning model may then be trained based on both sets of labels to determine three-dimensional bounding boxes, normal maps, or combinations thereof. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One aspect includes a method for image processing for use in a vehicle assistance system. The method includes receiving an image frame depicting an object. The method also includes receiving position data for the object. The method also includes determining, based on the position data, a first set of labels for the image frame, where the first set of labels identify where the object contacts a ground surface. The method also includes determining, based on the position data, a second set of labels, where the second set of labels identify at least one normal vector for the ground surface. The method also includes training a machine learning model based on the first set of labels and the second set of labels, where the machine learning model is trained to determine three-dimensional bounding boxes with corresponding contact locations.

Another aspect includes an apparatus that includes a memory storing processor-readable code and at least one processor coupled to the memory. The at least one processor may be configured to execute the processor-readable code to cause the at least one processor to perform operations including receiving an image frame depicting an object; receiving position data for the object; determining, based on the position data, a first set of labels for the image frame, where the first set of labels identify where the object contacts a ground surface; determining, based on the position data, a second set of labels, where the second set of labels identify at least one normal vector for the ground surface; and training a machine learning model based on the first set of labels and the second set of labels, where the machine learning model is trained to determine three-dimensional bounding boxes with corresponding contact locations.

An additional aspect includes a non-transitory computer-readable medium storing instructions that, when executed by a processor, cause the processor to perform operations including receiving an image frame depicting an object; receiving position data for the object; determining, based on the position data, a first set of labels for the image frame, where the first set of labels identify where the object contacts a ground surface; determining, based on the position data, a second set of labels, where the second set of labels identify at least one normal vector for the ground surface; and training a machine learning model based on the first set of labels and the second set of labels, where the machine learning model is trained to determine three-dimensional bounding boxes with corresponding contact locations.

A further aspect includes a vehicle that includes a memory storing processor-readable code and at least one processor coupled to the memory. The at least one processor may be configured to execute the processor-readable code to cause the at least one processor to perform operations including receiving an image frame depicting an object; receiving position data for the object; determining, based on the position data, a first set of labels for the image frame, where the first set of labels identify where the object contacts a ground surface; determining, based on the position data, a second set of labels, where the second set of labels identify at least one normal vector for the ground surface; and training a machine learning model based on the first set of labels and the second set of labels, where the machine learning model is trained to determine three-dimensional bounding boxes with corresponding contact locations.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks, such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology, such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example, implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to a wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus, and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, or packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring the teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating.” or the like refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating a system that supports terrain-aware object detection according to an exemplary embodiment of the present disclosure.

FIG. 5 depicts bounding boxes according to an exemplary embodiment of the present disclosure.

FIG. 6 is a flow chart illustrating an example method for terrain-aware object detection according to an exemplary embodiment of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support terrain-aware object detection. Many existing techniques for three-dimensional (3D) object detection assume that the road surface is flat. This assumption limits these techniques' ability to accurately detect objects on uneven terrain. In certain instances, annotated map information may be used to access ground elevation data. However, such annotated maps are not widely available.

Other techniques incorporate ground priors through plane-based parametrization. However, underlying assumptions for plane-based parameterization may typically require that (i) roads are straight and flat, (2) terrain is uniform and does not have significant elevation changes, and (3) objects on the road are stationary or move in a predictable manner. These assumptions may not always generalize well to real-world scenarios, where roads often have curves, hills, and valleys, and where objects on the road can move unpredictably. Therefore, a plane-based parametrization may not accurately capture the dynamics of the environment, leading to a deterioration in performance.

In further instances, sparse single scan LIDAR for 3D object detection may be used to estimate ground terrain conditions. However, such techniques may not be suitable for complicated terrain, where additional detail is needed. Therefore, there exists a need to accurately perform object detection in situations with non-flat road surfaces.

One solution to this problem is to train a machine learning model based on labels that identify contact points and ground surface normal vectors. To do so, image data may be received that is captured by a camera from an area around a vehicle. The image data may depict an object, and position data for the object may also be received. The position data may include point cloud position information for various points along an exterior surface of the object, which can be measured by a positional sensor.

A first set of labels may then be determined for the image frame based on the position data, which identify where the object contacts a ground surface. To determine the first set of labels, a bottom face of the bounding box may be divided into several sections and respective lowest position points may be determined from the position data located in each section. Contact locations may then determined based on these lowest position points. The labels may then be stored as metadata for corresponding positions within the image data.

A second set of labels may be determined based on the position data and may identify at least one normal vector for the ground surface. The normal vector may be determined as a vector perpendicular to the ground surface at a given point and may represent the direction perpendicular to the ground surface at the location of an object. This information can be used to calculate the orientation of an object with respect to its surroundings and may be added as metadata for a corresponding location.

A machine learning model may then be trained based on both the first set of labels and the second set of labels. The model may trained to determine three-dimensional bounding boxes with corresponding contact locations and may include indications of center locations, contact locations, and offset distances for contact locations. The model may also be trained to determine normal maps for terrain. Additionally, the machine learning model can be trained to fuse features from bounding boxes and normal maps to determine adjusted bounding boxes for top-down view maps surrounding vehicles. Finally, vehicle control instructions can be determined, such as based on the bounding boxes and/or normal maps, and may be used to regulate vehicle movement or support driver assistance programs.

Stated differently, existing approaches for 3D object detections assume a flat surface, which leads to poor performance and increased annotation costs. The proposed techniques utilize contact points to capture local occupancy of the object with respect to the ground plane and generate labels for contact points and normal vectors that can be used during feature extraction. Camera features may projected to a top-down view (e.g., bird's eye view (BEV)) space and may be fused with LIDAR scans. Predicted bounding boxes may then be fine-tuned based on normal predictions to output terrain-aware 3D object detection bounding boxes. Contact point labels may be generated using bounding box annotations on position data (such as LIDAR point clouds), and normal vector labels may be generated using multiple scans (such as multiple LIDAR scans). Such techniques may offer improved accuracy in detecting objects on non-flat roads, reducing annotation costs, and increasing efficiency in 3D object detection.

Particular implementations of the subject matter described in this disclosure may be implemented to realize one or more of the following potential advantages or benefits. In some aspects, the present disclosure provides techniques for image processing that may be particularly beneficial in smart vehicle applications. For example, the above techniques address the issues of existing object detection techniques in situations with uneven or non-flat terrain. In particular, these techniques can be used to train a model that is able to accurately detect objects without relying on map annotations that are not always available, inaccurate plane-based parameterization assumptions, or inadequate single scan LIDAR techniques. The techniques accordingly improve the accuracy of object detection for use in controlling or monitoring the operation of a vehicle, especially at long range where planar and flat road assumptions often fail. Furthermore, the techniques may reduce annotation costs, as they are able to determine the first and second sets of labels based on existing data annotations and may improve performance, as they do not rely on large, computationally expensive annotated maps.

These techniques can accordingly improve vehicle tracking. One major benefit of improved vehicle tracking is that it allows vehicle control systems to more accurately navigate vehicles around obstacles. This can be particularly useful in situations where there may be unexpected obstructions or road conditions that could pose a hazard to drivers. Additionally, improved tracking can help to improve overall safety on the roads by reducing vehicle collisions. With better tracking capabilities, vehicles can be made more responsive to nearby obstacles and can be routed around detected obstacles more efficiently. These improvements can also extend to driver assistance systems, which can benefit from increased monitoring capabilities. By expanding the number, type, and variety of surrounding vehicles that can be detected, these systems can offer more accurate alerts and assistance to drivers when necessary, without generating unnecessary notifications or distractions.

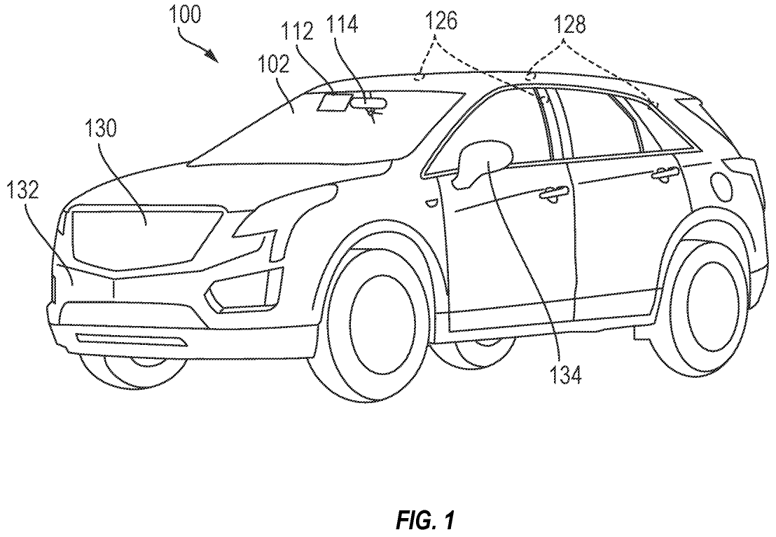

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or in a forward direction. In some embodiments, an additional camera may be located at the rear of the vehicle 100 and oriented such that the field of view of the additional camera captures a scene behind the vehicle 100 in the direction that the vehicle 100 is moving when in reverse mode or in a reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the vehicle 100 is traveling in a forward direction may likewise be obtained while the vehicle 100 is traveling in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

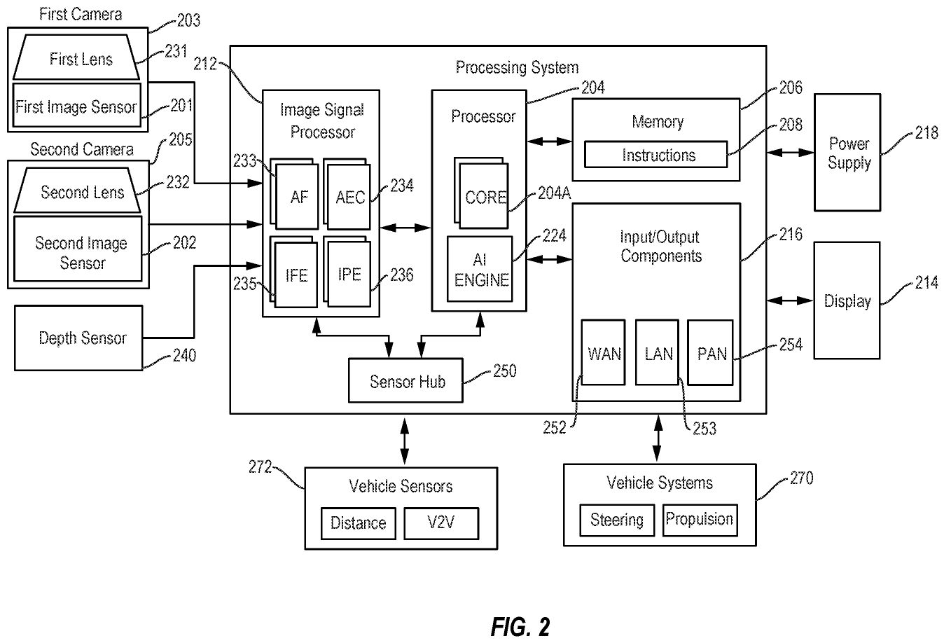

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes, or is coupled to, a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include, or be coupled to, a power supply 218, such as a battery or an alternator. The vehicle 100 may also include, or be coupled to, additional features or components that are not shown in FIG. 2. In one example, a wireless interface, which may include one or more transceivers and associated baseband processors, may be coupled to, or included in, WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjusts the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to, or included in, the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

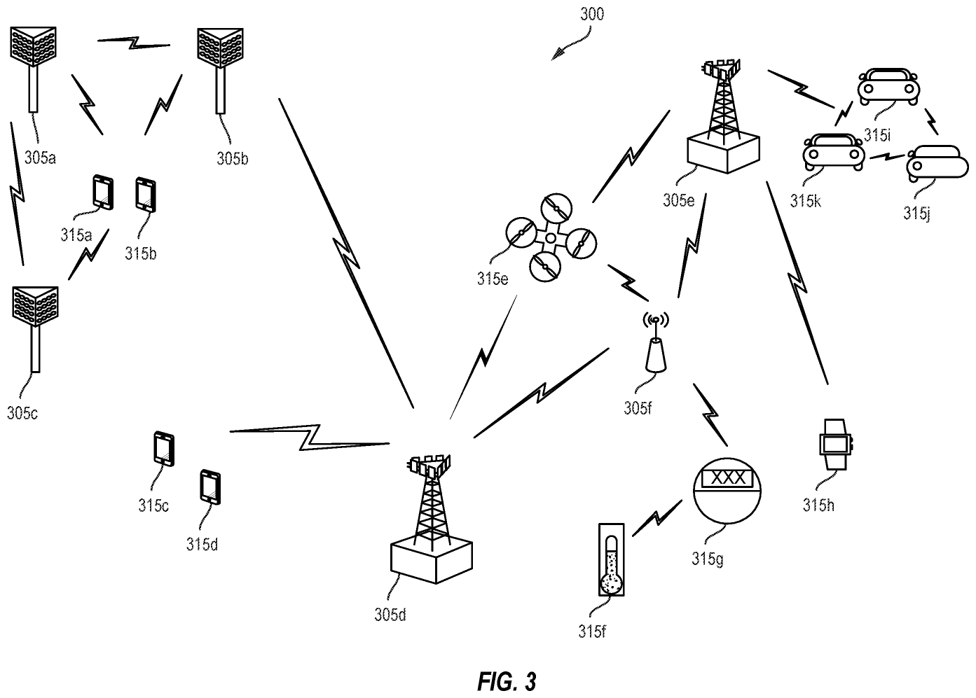

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, which may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (cMTC), narrowband IoT (NB-IoT) and the like. UEs 315c-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or streaming video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305c.

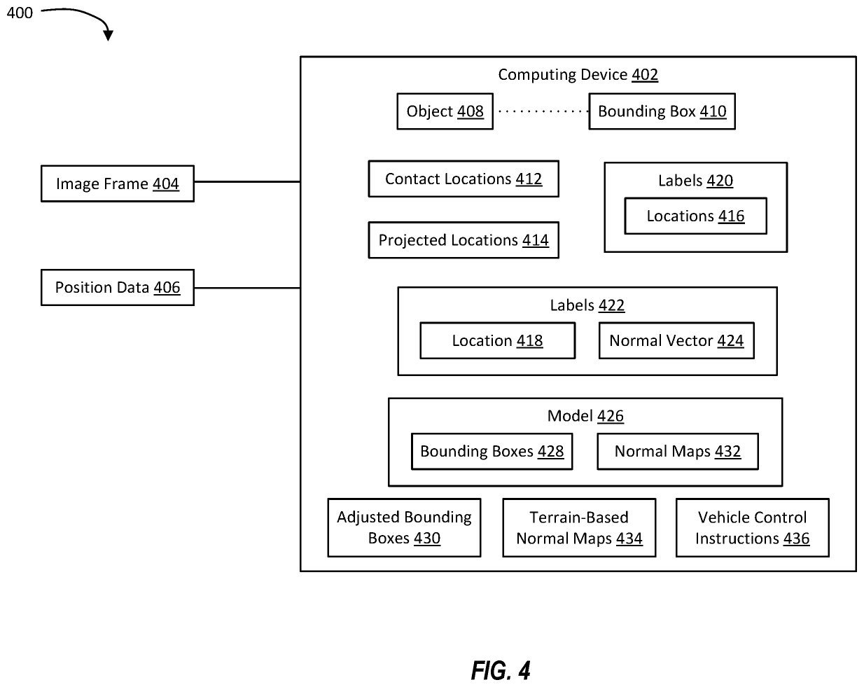

Aspects of the vehicular systems described with reference to, and shown in, FIG. 1, FIG. 2, and FIG. 3 may include terrain-aware object detection. For example, FIG. 4 is a block diagram illustrating a system 400 that supports terrain-aware object detection according to an exemplary embodiment of the present disclosure. The system 400 includes position data 406, an image frame 404, and a computing device 402. The computing device 402 includes an object 408, a bounding box 410, a first set of labels 420, contact locations 412, projected locations 414, a second set of labels 422, a model 426, adjusted bounding boxes 430, terrain-based normal maps 434, and vehicle control instructions 436. The first set of labels 420 includes locations 416 and the second set of labels 422 includes locations 418 and a normal vector 424. The model 426 includes bounding boxes 428 and normal maps 432. The system 400 may be an exemplary implementation of one or more above-discussed aspects. For example, the system 400 may be contained within the vehicle 100, may be an exemplary implementation of the processing system in FIG. 2 (such as the ISP 212, the processor 204, or combinations thereof), and the like.

The computing device 402 may be configured to receive an image frame 404 depicting an object 408. In certain implementations, the received image frame 404 may be captured from an area around a vehicle. For example, the vehicle may be equipped with one or more cameras. These cameras may be configured to capture images on a regular basis. The captured images may cover a wide range of angles and distances, providing a comprehensive view of the area around the vehicle. In certain implementations, the image frame 404 may include a single image that has been captured by a single camera. In other implementations, the image frame 404 may include multiple image frames that have been captured by a single camera, such as a stream of image frame 404 captured by the camera. In additional or alternative implementations, the image frame 404 may include multiple image frames that have been captured by multiple cameras, such as multiple cameras facing different portions of an area surrounding the vehicle. In certain implementations, the object 408 may include any object 408 located in an area surrounding the vehicle, such as road signs, vehicles, buildings, and the like. In certain implementations, the object 408 may be mobile. For example, the object 408 may include one or more of other vehicles, pedestrians, bicycles, scooters, and the like. In certain implementations, the object 408 may have been previously detected within the image frame 404 by one or more image detection processes implemented by the computing device 402 or another computing device 402. In certain implementations, the object 408 may be identified by a bounding box 410 or other identifier within the image frame 404.

The computing device 402 may be configured to receive position data 406 for the object 408. In certain implementations, the position data 406 may be obtained from the same vehicle that captures the image frame 404 for the object 408. The position data 406 may include point cloud position information for various points along an exterior surface of the object 408 and may also include position information for other objects or an area surrounding the object 408. In some implementations, the position data 406 may be raw position points measured by a positional sensor (such as a LIDAR sensor, an ultrasonic position sensor, and the like). In additional or alternative implementations, the position data 406 may have been previously processed to extract position points from the position data 406 that correspond to the object 408. For instance, a bounding box 410 may be determined for the object 408, and the position data 406 may include a subset of measured position data 406 contained within the bounding box 410. Additionally or alternatively, the position data 406 points may be tagged with identifiers of corresponding objects, and only those points corresponding to the current object 408 (such as the current object 408 in a processing pipeline) may be received by the computing device 402. In instances where raw position data 406 is received, the computing device 402 may be configured to perform one or more of the above processing operations.

The computing device 402 may be configured to determine, based on the position data 406, a first set of labels 420 for the image frame 404. The first set of labels 420 may identify where the object 408 contacts a ground surface. In certain implementations, the ground surface may refer to the ground or other terrain on which the object 408 is located, which can include roads, sidewalks, bridges, parking structures, or any other surface that supports the object 408. The ground surface may be flat and/or may vary in height and/or shape near the vehicle, such as due to curves, slopes, banks, or other factors in close proximity to the vehicle. In certain implementations, the labels may be used to train machine learning models and may be assigned to specific positions, such as three-dimensional coordinates for an area containing the object 408, pixel locations within an image, or combinations thereof. In some cases, the labels 420 may be implemented as metadata for the corresponding positions. In certain implementations, the first set of labels 420 may be considered “pseudo-labels.” For example, in certain implementations, the term “labels” may refer to manually generated, annotated, or otherwise verified training data values. As explained further below, the first set of labels 420 may be determined based off of other labels and may accordingly be referred to or otherwise understood as pseudo labels instead, as the first set of labels 420 were not themselves directly verified by annotators.

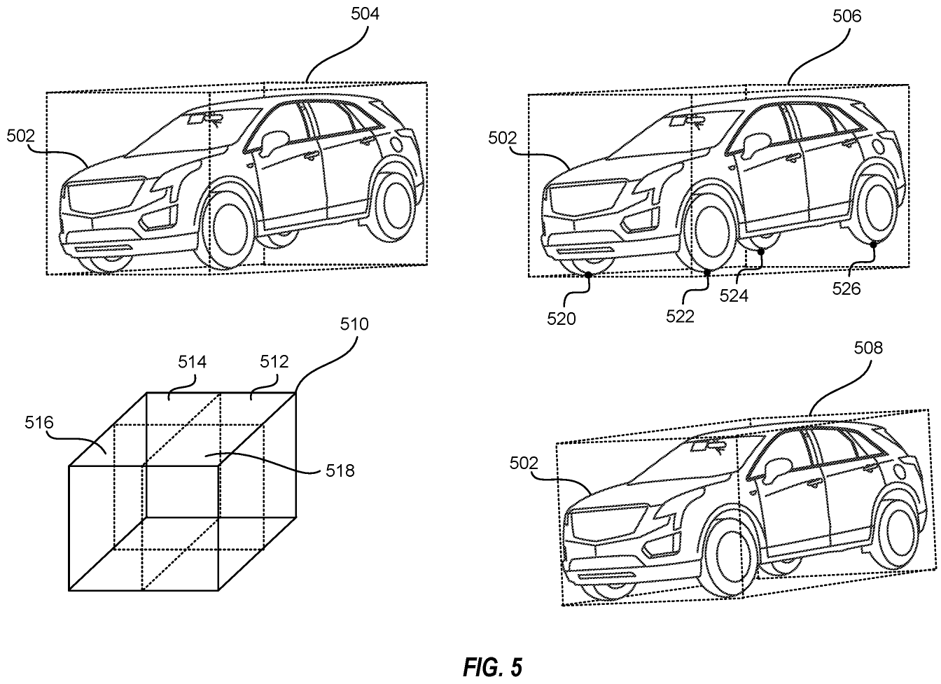

In certain implementations, determining the first set of labels 420 may include, determining, based on a bounding box 410 of the object 408, contact locations 412 where the object 408 contacts the ground surface. For example, FIG. 5 depicts a bounding box 506 that includes contact locations 520, 522, 524, 526 of the vehicle 502 according to an exemplary embodiment of the present disclosure. In certain implementations, the bounding box 506 may be included as part of LIDAR data. For example, the LIDAR data may include bounding boxes for detected objects in a LIDAR frame. Projected locations 414 of the contact locations 412 may then be determined within the image frame 404. For example, three-dimensional coordinates for the contact locations 412 may be projected onto the image frame 404 using perspective projection. In certain implementations, the computing device 402 may determine the projected location based on a relative viewing distance and angle of the object 408 within the image frame 404. To account for occluded points on the object 408, the computing device 402 may use algorithms to estimate occluded or hidden contact locations 412 based on their known positions and may similarly determine the projected locations 414 for the occluded locations. In certain implementations, the projected locations 414 may be determined as pixel locations within the image frame 404. In certain implementations, locations 416 for the first set of labels 420 may then be determined based on the projected locations 414. In certain implementations, the first set of labels 420 may be assigned to the projected locations 414 (such as pixel locations within the image frame 404 that correspond to the projected locations 414). Assigning the labels 420 may include assigning corresponding metadata for the first set of labels 420 to the corresponding locations 416 (such as assigning label metadata of “contact point” or similar to the corresponding pixel location).

In certain implementations, determining the contact locations 412 may include dividing the bounding box 410 into a plurality of sections, determining, for each respective section of the plurality of sections, a respective lowest position point from the position data 406 located in the respective section, and determining the contact locations 412 based on the respective lowest position points. In certain implementations, the bounding box 410 may be divided into sections using vertical planes relative to the object 408. For example, if the object 408 may be a vehicle, the bounding box 410 may be divided into four sections: a front-right section, a front-left section, a rear-right section, and a rear-left section. As a specific example, FIG. 5 depicts a vehicle 502 with an initial bounding box 504, which may be an exemplary implementation of the bounding box 410. FIG. 5 also depicts a divided bounding box 510, which is divided into four sections 512, 514, 516, 518 by vertical planes. As another example, if the object 408 is a motorcycle, the bounding box 410 may be divided into two sections a front section and a rear section. In certain implementations, the number of sections may be determined based on the type of object 408. For example, as noted previously, if the object 408 is a car or other large vehicle (such as a bus, truck, and the like), the bounding box 410 may be divided into four sections. As another example, if the object 408 is a motorcycle, bicycle, scooter, or other small vehicle, the bounding box 410 may be divided into two sections. As a further example, if the object 408 is a pedestrian, the bounding box 410 may be divided into two sections.

In certain implementations, the lowest position point for each section may be identified as the position point contained within the section that has the lowest elevation value. In certain implementations, the computing device may be configured to consider among all position data 406 contained within the section. In additional or alternative implementations, the computing device 402 may consider or otherwise analyze only a subset of the position points within a particular section (such as points that contact a bottom surface of the section or points that are located within a threshold distances of the bottom surface).

In certain implementations, prior to identifying the lowest position points and/or prior to dividing the bounding box 410, the computing device 402 may be configured to remove ground points from the position data 406. For example, the computing device 402 may be configured to use elevation thresholds, slope analysis, point classification, and the like to identify and remove ground points. Elevation thresholding may include setting a minimum height threshold to exclude ground points below the threshold. Slope analysis may identify steep areas within the position data 406 as unlikely to contain ground points. Point classification may analyze included metadata for the position points and may remove points with corresponding metadata that identifies the point as a ground point.

In certain implementations, the contact locations 412 may be determined as position distributions. In additional or alternative implementations, the contact locations 412 may be precisely determined as specific positions, such as three-dimensional coordinates where the object 408 contacts the ground surface. However, in some cases, it may not be possible to accurately determine an exact position for certain contact locations 412, such as for contact locations that are occluded and lack precise position data 406. Additionally, downstream processing may not require exact positions, allowing for greater flexibility in determining contact locations 412. In such instances, the contact locations 412 may instead be determined as position distributions. The position distributions may identify a particular region where contact points between the object 408 and ground surface may occur and may include corresponding probabilities for positions within that region. For example, the probabilities may vary based on distance from the center of the region, with higher probabilities near the center.

The computing device 402 may be configured to determine, based on the position data 406, a second set of labels 422. The second set of labels 422 may identify at least one normal vector 424 for the ground surface. In certain implementations, the normal vector 424 for the ground surface may be determined as a vector that may be perpendicular to the ground surface at a given point. In certain implementations, the normal vector 424 represents the direction that is perpendicular to the ground surface at the location of the object 408 (such as at a center of the object 408, a contact location for the object 408, or combinations thereof). Normal vectors may represent an angle or direction of the ground surface under the object 408, which may be used to calculate the orientation of the object 408 with respect to its surroundings (such as pitch, yaw, and roll angles for the object 408). In certain implementations, a single normal vector 424 may be determined for each object 408. For example, a single normal vector 424 may be determined for the ground surface under the object 408 (i.e., under the vehicle).

In certain implementations, determining the second set of labels 422 includes determining at least a subset of position data 406 corresponding to the ground surface, determining at least one normal vector 424 based on at least the subset of the position data 406, and determining the second set of labels 422 based on the at least one normal vector 424. In certain implementations, the at least the subset of position data 406 corresponding to the ground surface may be identified using one or more of the above-described techniques for identifying ground surface position points (such as elevation thresholds, slope analysis, point classification and the like). In certain implementations, the normal vectors 424 may be determined as orthogonal to the ground surface as represented by at least the subset of the position data 406. In certain implementations, the computing device 402 may be configured to determine the normal vector 424 using one or more surface normal estimation techniques. For example, the computing device 402 may determine the average orientation of neighboring points around points within at least the subset of the position data 406. The average orientation across the points may return an estimate of the normal vector 424 for the ground surface (such as for at least the subset of the position data 406 corresponding to the ground surface). Additionally or alternatively, the computing device 402 may be configured to determine the normal vector 424 using one or more local plane fitting techniques. For example, the computing device 402 may be configured to fit a plane to points from at least the subset of the position data 406 and to compute the normal vector 424 as the normal vector for that plane. In such implementations, the computing device 402 may determine the plane using techniques such as principal component analysis, least-squares fitting, and the like.

In certain implementations, determining the at least one normal vector 424 may include determining a low-density area in the position data 406 and determining adjusted position data by applying morphological operations to the low-density area in the position data 406. In particular, the computing device 402 may be configured to determine the adjusted position data to fill in position points (such as estimated position points) for the low-density area. In certain implementations, the low-density area may be determined as two- or three-dimensional region within at least the subset of the position data 406 with a position point density below a predetermined threshold (such as 0.5 points per cubic foot, 1 point per cubic foot, 5 points per cubic foot, and the like). In certain implementations, morphological operations may include data processing techniques that involve manipulating the shape and structure of data points (such as position points from the position data 406). In certain implementations, the morphological operations may include one or more erosion operations, dilation operations, opening operations, closing operations, morphological gradient operations, top-hat transformations, black-hat transformations, hit-or-miss transformations, or combinations thereof. In certain implementations, the at least one normal vector 424 may be determined, at least in part, based on the adjusted position data 406. In certain implementations, the normal vector 424 may be determined using at least one corrected/supplemental point from the low-density area contained within the adjusted position data 406 (such as one or more points adjusted or created using the morphological operations).

In certain implementations, prior to determining the normal vector 424, the computing device 402 may be configured to apply motion compensation techniques to the position data 406. As a specific example, the position data 406 may include multiple frames (such as 2 frames, 5 frames, 10 frames, and the like) of position data 406 captured by a positioning sensor (such as a LIDAR sensor). In one specific implementation, the position data 406 may include the previous 5 frames, and the vehicle may have moved while capturing the frames, causing distortion of the measured position points. The motion compensation may be performed to correct for these distortions. For example, the motion compensation techniques may include one or more of inertial measurement unit (IMU)-aided motion compensation, Global Positioning System (GPS)-aided motion compensation, iterative closest point (ICP) identification, scan matching, and simultaneous localization and mapping (SLAM)-based techniques.

In certain implementations, the second set of labels 422 may be added as corresponding metadata. For example, the second set of labels 422 may be added as metadata whose contents indicate the direction of the normal vector 424. Additionally, in certain implementations, the second set of labels 422 may be added to a terrain map, such as a terrain map for an area surrounding the vehicle. For example, the terrain map may be a top-down terrain map, such as a bird's eye view (BEV) terrain map for the area surrounding the vehicle. The terrain map may include identifiers of objects, corresponding bounding boxes, and normal vectors at various locations within the area surrounding the vehicle. In such instances, the second set of labels 422 may be added as corresponding metadata at a position corresponding to the object 408 (such as at a center of the object 408, a contact location for the object 408, a bounding box for the object 408, or combinations thereof). In certain implementations, the bounding box 410 for the object 408 may be updated based on the determined normal vector 424. Updating the bounding box 410 may include adjusting one or more of a pitch angle, yaw angle, roll angle, center location of the bounding box 410, or combinations thereof based on the normal vector 424. The adjustment may be made to align the object 408 with the normal vector 424 (such as to align a normal vector of the top of the bounding box 410 with the normal vector 424 for the ground surface). In particular, updating the bounding box 410 may include correcting all three of the pitch, yaw, and roll angles for the bounding box 410. Additionally or alternatively, the bounding box 410 for the object 408 may be updated based on the contact locations 412. For example, the bounding box 410 may be updated to ensure that the bottom surface of the bounding box 410 aligns with the contact locations 412. FIG. 5 depicts an example of an adjusted bounding box 508 according to an exemplary embodiment of the present disclosure. When compared to the bounding box 504, the adjusted bounding box 508 has been adjusted to correct pitch, yaw, and roll angles and accordingly better aligns with the actual location of the vehicle 502.

The computing device 402 may be configured to train a machine learning model 426 based on the first set of labels 420 and the second set of labels 422. The machine learning model 426 may be trained to determine three-dimensional bounding boxes 428 with corresponding contact locations. As one skilled in the art will appreciate, bounding boxes may typically be specified using a collection of dimensions and location information, such as (x, y, z) coordinates for a center of the bounding box and the length, width, and height of the bounding box. In certain implementations, the three-dimensional bounding boxes 428 determined by the machine learning model 426 may contain additional or alternative information. For example, the bounding boxes 428 may include indications of (i) a center location for the bounding box 410 and (ii) contact locations for the bounding boxes 428. In certain implementations, the bounding boxes 428 may further include an indication of the class or type of a detected object (such as cards, pedestrians, traffic signs, and the like). In certain implementations, the contact locations 412 may be indicated using position distributions, as described above. In certain implementations, the contact locations 412 may further include offset distances for the contact locations 412 from the center location. In certain implementations, the three-dimensional bounding boxes 428 may be determined from a perspective view. In additional or alternative implementations, bounding boxes 428 may be determined from one or more other views (such as a top-down view).

In certain implementations, the machine learning model 426 may be further configured to determine normal maps 432 based on image data. In certain implementations, the normal maps 432 may be terrain aware, indicating that the maps include different normal vectors 424 at different locations, determined based on changes in the terrain. In certain implementations, the normal maps 432 may be determined from a top-down view. In additional or alternative implementations, the normal maps 432 may be determined from one or more other views (such as a perspective view).

In certain implementations, the machine learning model 426 may be an object detection model, such as a three-dimensional object detection model. For example, the machine learning model 426 may include one or more neural network-based models (such as one or more convolutional neural networks, recurrent neural networks, and the like). In additional or alternative implementations, the machine learning model 426 may include one or more of a two-stage object detection model, a one-stage object detection model, multi-scale models, anchor-based models, anchor-free models, ensemble models, and the like. Furthermore, the machine learning model 426 may be trained using various techniques, such as supervised learning, unsupervised learning, semi-supervised learning, reinforcement learning, transfer learning, and the like.

In certain implementations, one or both of the first set of labels 420 and the second set of labels 422 are used to supervise a training process for the machine learning model 426. For example, the computing device 402 may use the first set of labels 420 and the second set of labels 422 to supervise the training process for the machine learning model 426. In certain implementations, supervising the training process may include using the first set of labels 420 and the second set of labels 422 in one or more loss functions for the training process. In certain implementations, the loss functions may be computed as:

$$\begin{matrix}{ℒ}_{cp} = {ℒ}_{cp , heatmap} + {ℒ}_{cp , offset} + {ℒ}_{cp , center} \\ = Focal ( \hat{x} , x ) + {ℒ}_{1} ( {\hat{x}}_{offset} , {x}_{offset} ) + {ℒ}_{1} ( {\hat{x}}_{center} , {x}_{center} ) ,\end{matrix}$$

where:
[symbol] _{cp} is the loss function for the model 426,
[symbol] _{cp,heatmap} is the loss function for position distributions (“heatmaps”) for the contact locations, which may be determined as a focal loss (such as a difference in focus or size of position distributions) based on differences between predicted position distributions (x) and position distributions from the first set of labels (\hat{x}),
[symbol] _{cp,offset} is the loss function for contact point offsets from a center coordinate of the bounding boxes, which may be determined as an L1 loss between predicted contact point offsets (x_{offset}) and contact point offsets from the first set of labels (\hat{x}_{offset}), and
[symbol] _{cp,center} is the loss function for center point locations of bounding boxes, which may be determined as an L1 loss between predicted center point locations (x_{center}) and center point locations from the first set of labels (\hat{x}_{center}).

In certain implementations, the first set of labels 420 used to supervise an image processing pipeline and the second set of labels 422 may be used to supervise a position data pipeline. For example, the computing device 402 may be configured to separately process image data and position data before the processed data is provided to the machine learning model 426. In such instances, the image data may be processed by an image processing pipeline that is configured to perform one or more of camera feature extraction, perspective view feature extraction, top-down view projection, or combinations thereof. Additionally or alternatively, the position data 406 may be processed by a position data pipeline that includes perspective sensor feature extraction, sparse feature extraction, flattening projection for a top-down view, or combinations thereof. In certain implementations, all or part of the image processing pipeline, the position data pipeline, or combinations thereof may be implemented using one or more machine learning models, which may be trained based on the first set of labels 420 and/or the second set of labels 422.

In certain implementations, all or part of the above-described techniques may be repeated multiple times (such as for multiple images, multiple objects within each image, or combinations thereof) to generate a training dataset that may be used to train the model 426. For example, the model 426 may be implemented as one or more machine learning models, including supervised learning models, unsupervised learning models, other types of machine learning models, and/or other types of predictive models. For example, the model 426 may be implemented as one or more of a neural network, a transformer model, a decision tree model, a support vector machine, a Bayesian network, a classifier model, a regression model, and the like. The model 426 may be trained based on training data to detect objects based on received image and/or position data. For example, one or more training datasets may be used that contain the first set of labels and/or the second set of labels, specifying one or more expected outputs. Parameters of the model 426 may be updated based on whether the model 426 generates correct outputs when compared to the expected outputs. In particular, the model 426 may receive one or more pieces of input data from the training data sets that are associated with a plurality of expected outputs. The model 426 may generate predicted outputs based on a current configuration of the model 426. The predicted outputs may be compared to the expected outputs, and one or more parameter updates may be computed based on differences between the predicted outputs and the expected outputs. In particular, the parameters may include weights (e.g., priorities) for different features and combinations of features. The parameter updates to the model 426 may include updating one or more of the features analyzed and/or the weights assigned to different features or combinations of features (e.g., relative to the current configuration of the model 426).

In certain implementations, the machine learning model 426 may be further trained to fuse features from the three-dimensional bounding boxes 428 and the normal maps 432, such as to determine adjusted bounding boxes 430 for top-down view maps of areas surrounding vehicles. As one skilled in the art will appreciate, feature fusion may be used to combine multiple features to create a new feature, which can then be used as an input for a model 426 instead of using the individual features separately. Feature fusion can be done in different ways such as concatenation, addition, multiplication, averaging, and the like. In certain implementations, the parameters for the three-dimensional bounding boxes 428 and parameters for the normal maps 432 may be concatenated to form a single feature vector that is processed by a machine learning model (such as the model 426, another model, or combinations thereof) to determine the adjusted bounding boxes 430. As noted previously, the adjusted bounding boxes 430 may include additional information, such as a yaw angle, a roll angle, a pitch angle, or combinations thereof.

In certain implementations, vehicle control instructions 436 for a vehicle may be determined based on the model 426. For example, three-dimensional bounding boxes 428 determined by the machine learning model 426 may be used to determine the vehicle control instructions 436. For example, the bounding boxes 428 may indicate the positions of obstacles or other objects that the vehicle needs to navigate around or avoid. As explained above, in some implementations, the bounding boxes 428 may be fused with normal maps 432. In such instances, the resulting adjusted bounding boxes 430 may then be used to determine the vehicle control instructions 436. In certain implementations, vehicle control instructions 436 may refer to the set of commands and guidelines that directly or indirectly regulate the movement of a vehicle. These instructions may come in the form of direct vehicular control instructions, such as steering, braking, accelerating, or combinations thereof. In additional or alternative implementations, vehicle control instructions 436 may be supplementary instructions that support driver assistance programs, such as obstacle avoidance, blind spot monitoring, and other driver assistance alerts. Control instructions may accordingly help drivers to maintain safe operation of vehicles while driving on roads and highways.

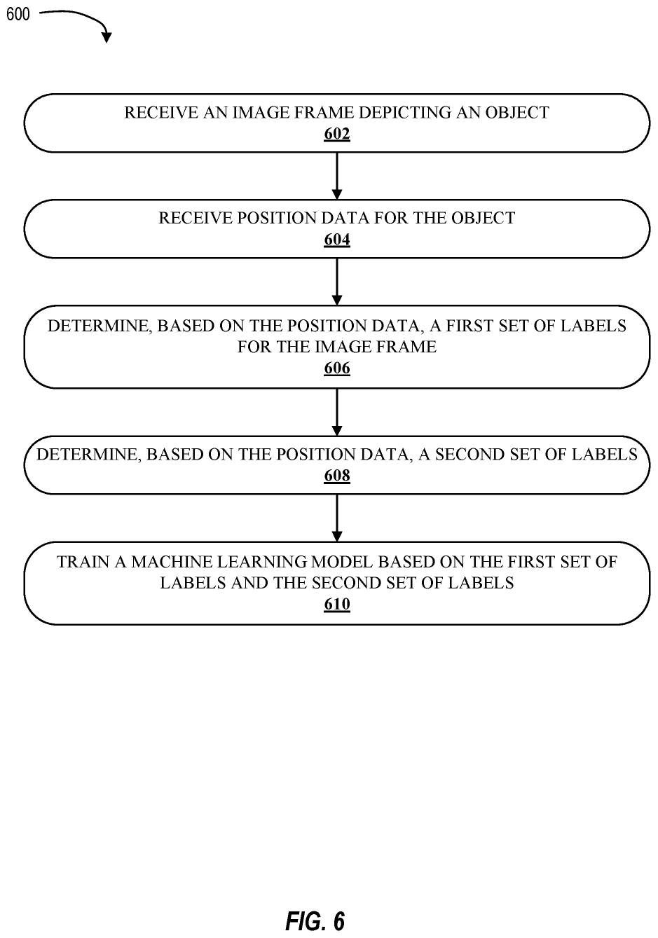

One method of performing image processing according to embodiments described above is shown in FIG. 6. FIG. 6 is a flow chart illustrating an example method 600 for terrain-aware object detection. The method may be performed by one or more of the above systems, such as the systems 100, 200, 300, 400.

The method 600 includes receiving an image frame depicting an object (block 602). For example, the computing device 402 may receive an image frame 404 depicting an object 408. In certain implementations, the received image frame 404 may be captured from an area around a vehicle. In certain implementations, the object 408 may include any object 408 located in an area surrounding the vehicle, such as road signs, vehicles, buildings, and the like. In certain implementations, the object 408 may be mobile. For example, the object 408 may include one or more of other vehicles, pedestrians, bicycles, scooters, and the like. In certain implementations, the object 408 may be identified by a bounding box 410 or other identifier within the image frame 404.

The method 600 includes receiving position data for the object (block 604). For example, the computing device 402 may receive position data 406 for the object 408. The position data 406 may include point cloud position information for various points along an exterior surface of the object 408 and may also include position information for other objects in an area surrounding the object 408.

The method 600 includes determining, based on the position data, a first set of labels for the image frame (block 606). For example, the computing device 402 may determine, based on the position data 406, a first set of labels 420 for the image frame 404. The first set of labels 420 may identify where the object 408 contacts a ground surface. In certain implementations, the ground surface may refer to the ground or other terrain on which the object 408 is situated, which can include roads, sidewalks, bridges, parking structures, or any other surface that supports the object 408. In certain implementations, the labels may be used to train machine learning models and may be assigned to specific positions, such as three-dimensional coordinates for an area containing the object 408, pixel locations within an image, or combinations thereof. In some cases, the labels may be implemented as metadata for the corresponding positions.

In certain implementations, determining the first set of labels 420 includes determining, based on a bounding box 410 of the object 408, contact locations 412 where the object 408 contacts the ground surface, determining projected locations 414 of the contact locations 412 within the image frame 404, and determining locations 416 for the first set of labels 420 based on the projected locations 414. In certain implementations, determining the contact locations 412 includes dividing the bounding box 410 into a plurality of sections, determining, for each respective section of the plurality of sections, a respective lowest position point from the position data 406 located in the respective section and determining the contact locations 412 based on the respective lowest position points. In certain implementations, the bounding box 410 may be divided into sections using vertical planes relative to the object 408. In certain implementations, the number of sections may be determined based on the type of object 408. In certain implementations, the lowest position point may be identified from among all position data 406 contained within the corresponding section. In additional or alternative implementations, the computing device 402 may consider or otherwise analyze only a subset of the points within a particular section. In certain implementations, prior to identifying the lowest position points and/or prior to dividing the bounding box 410, the computing device 402 may be configured to remove ground points from the position data 406. In certain implementations, the contact locations 412 are determined as position distributions.

The method 600 includes determining, based on the position data, a second set of labels (block 608). For example, the computing device 402 may determine, based on the position data 406, a second set of labels 422. The second set of labels 422 may identify at least one normal vector 424 for the ground surface. In certain implementations, the normal vector 424 for the ground surface may be determined as a vector that is perpendicular to the ground surface at a given point. In certain implementations, determining the second set of labels 422 includes determining at least a subset of the position data 406 corresponding to the ground surface, determining at least one normal vector 424 based on at least the subset of the position data 406, and determining the second set of labels 422 based on the at least one normal vector 424. In certain implementations, prior to determining the normal vector 424, the computing device 402 may be configured to apply motion compensation techniques to the position data 406. In certain implementations, the normal vectors 424 may be determined as orthogonal to the ground surface as represented by at least the subset of the position data 406. In certain implementations, determining the at least one normal vector 424 may include determining a low density area in the position data 406 and determining adjusted position data 406 by applying morphological operations to the low density area in the position data 406. In such instances, the at least one normal vector 424 may be determined, at least in part, based on the adjusted position data 406.

The method 600 includes training a machine learning model based on the first set of labels 420 and the second set of labels 422 (block 610). For example, the computing device 402 may train a machine learning model 426 based on the first set of labels 420 and the second set of labels 422. The machine learning model 426 may be trained to determine three-dimensional bounding boxes 428 with corresponding contact locations 412. In certain implementations, one or both of the first set of labels 420 and the second set of labels 422 are used to supervise a training process for the machine learning model 426. For example, the computing device 402 may use the first set of labels 420 and the second set of labels 422 to supervise the training process for the machine learning model 426. In certain implementations, the machine learning model 426 may be further configured to determine normal maps 432. In certain implementations, the machine learning model 426 may be further trained to fuse features from the three-dimensional bounding boxes 428 and the normal maps 432 to determine adjusted bounding boxes 430 for top-down view maps of areas surrounding vehicles. In certain implementations, the method 600 may further include determining, based at least in part on the machine learning model 426, vehicle control instructions 436 for a vehicle. In certain implementations, bounding boxes 428 determined by the machine learning model 426 may be used to determine the vehicle control instructions 436.

It is noted that one or more blocks (or operations) described with reference to FIG. 6 may be combined with one or more blocks (or operations) described with reference to another of the figures. For example, one or more blocks (or operations) of FIG. 6 may be combined with one or more blocks (or operations) of FIG. 1-3. As another example, one or more blocks associated with FIG. 6 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein. A first aspect includes a method for image processing for use in a vehicle assistance system. The method includes receiving an image frame depicting an object. The method also includes receiving position data for the object. The method also includes determining, based on the position data, a first set of labels for the image frame, where the first set of labels identify where the object contacts a ground surface. The method also includes determining, based on the position data, a second set of labels, where the second set of labels identify at least one normal vector for the ground surface. The method also includes training a machine learning model based on the first set of labels and the second set of labels, where the machine learning model is trained to determine three-dimensional bounding boxes with corresponding contact locations.

In a second aspect, in combination with the first aspect, determining the first set of labels includes determining, based on a bounding box of the object, contact locations where the object contacts the ground surface; determining projected locations of the contact locations within the image frame; and determining locations for the first set of labels based on the projected locations.

In a third aspect, in combination with the second aspect, determining the contact locations includes dividing the bounding box into a plurality of sections; determining, for each respective section of the plurality of sections, a respective lowest position point from the position data located in the respective section; and determining the contact locations based on the respective lowest position points.

In a fourth aspect, in combination with one or more of the second aspect through the third aspect, the contact locations are determined as position distributions.

In a fifth aspect, in combination with one or more of the first aspect through the fourth aspect, determining the second set of labels includes determining at least a subset of the position data corresponding to the ground surface; determining the at least one normal vector based on at least the subset of the position data; and determining the second set of labels based on the at least one normal vector.

In a sixth aspect, in combination with the fifth aspect, determining the at least one normal vector includes determining a low density area in the position data; and determining adjusted position data by applying morphological operations to the low density area in the position data, where the at least one normal vector is determined at least in part based on the adjusted position data.

In a seventh aspect, in combination with one or more of the first aspect through the sixth aspect, one or both of the first set of labels and the second set of labels are used to supervise a training process for the machine learning model.

In an eighth aspect, in combination with the seventh aspect, supervising the training process includes using the first set of labels and the second set of labels in one or more loss functions for the training process.

In a ninth aspect, in combination with one or more of the first aspect through the eighth aspect, the machine learning model is further configured to determine normal maps based on image data.

In a tenth aspect, in combination with the ninth aspect, the machine learning model is further trained to fuse features from the three-dimensional bounding boxes and the normal maps to determine adjusted bounding boxes for top-down view maps of areas surrounding vehicles.

In an eleventh aspect, in combination with one or more of the first aspect through the tenth aspect, the method further includes determining, based at least in part on the machine learning model, vehicle control instructions for a vehicle.

In a twelfth aspect, in combination with the eleventh aspect, three-dimensional bounding boxes determined by the machine learning model are used to determine the vehicle control instructions.

A thirteenth aspect includes an apparatus that includes a memory storing processor-readable code and at least one processor coupled to the memory. The at least one processor may be configured to execute the processor-readable code to cause the at least one processor to perform operations including receiving an image frame depicting an object; receiving position data for the object; determining, based on the position data, a first set of labels for the image frame, where the first set of labels identify where the object contacts a ground surface; determining, based on the position data, a second set of labels, where the second set of labels identify at least one normal vector for the ground surface; and training a machine learning model based on the first set of labels and the second set of labels, where the machine learning model is trained to determine three-dimensional bounding boxes with corresponding contact locations. In some implementations, the apparatus includes a wireless device, such as a UE. In some implementations, the apparatus may include at least one processor and a memory coupled to the processor. The processor may be configured to perform operations described herein with respect to the apparatus. In some other implementations, the apparatus may include a non-transitory computer-readable medium having program code recorded thereon, and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a fourteenth aspect, in combination with the thirteenth aspect, determining the first set of labels includes determining, based on a bounding box of the object, contact locations where the object contacts the ground surface; determining projected locations of the contact locations within the image frame; and determining locations for the first set of labels based on the projected locations.

In a fifteenth aspect, in combination with the fourteenth aspect, determining the contact locations includes dividing the bounding box into a plurality of sections; determining, for each respective section of the plurality of sections, a respective lowest position point from the position data located in the respective section; and determining the contact locations based on the respective lowest position points.

In a sixteenth aspect, in combination with one or more of the fourteenth aspect through the fifteenth aspect, the contact locations are determined as position distributions.

In a seventeenth aspect, in combination with one or more of the thirteenth aspect through the sixteenth aspect, determining the second set of labels includes determining at least a subset of the position data corresponding to the ground surface; determining the at least one normal vector based on at least the subset of the position data; and determining the second set of labels based on the at least one normal vector.

In an eighteenth aspect, in combination with the seventeenth aspect, determining the at least one normal vector includes determining a low density area in the position data; and determining adjusted position data by applying morphological operations to the low density area in the position data, where the at least one normal vector is determined at least in part based on the adjusted position data.

In a nineteenth aspect, in combination with one or more of the thirteenth aspect through the eighteenth aspect, one or both of the first set of labels and the second set of labels are used to supervise a training process for the machine learning model.

In a twentieth aspect, in combination with one or more of the thirteenth aspect through the nineteenth aspect, the machine learning model is further configured to determine normal maps based on image data.

A twenty-first aspect includes a non-transitory computer-readable medium storing instructions that, when executed by a processor, cause the processor to perform operations including receiving an image frame depicting an object; receiving position data for the object; determining, based on the position data, a first set of labels for the image frame, where the first set of labels identify where the object contacts a ground surface; determining, based on the position data, a second set of labels, where the second set of labels identify at least one normal vector for the ground surface; and training a machine learning model based on the first set of labels and the second set of labels, where the machine learning model is trained to determine three-dimensional bounding boxes with corresponding contact locations.

In a twenty-second aspect, in combination with the twenty-first aspect, determining the first set of labels includes determining, based on a bounding box of the object, contact locations where the object contacts the ground surface; determining projected locations of the contact locations within the image frame; and determining locations for the first set of labels based on the projected locations.

In a twenty-third aspect, in combination with the twenty-second aspect, determining the contact locations includes dividing the bounding box into a plurality of sections; determining, for each respective section of the plurality of sections, a respective lowest position point from the position data located in the respective section; and determining the contact locations based on the respective lowest position points.

In a twenty-fourth aspect, in combination with one or more of the twenty-first aspect through the twenty-third aspect, determining the second set of labels includes determining at least a subset of the position data corresponding to the ground surface; determining the at least one normal vector based on at least the subset of the position data; and determining the second set of labels based on the at least one normal vector.

In a twenty-fifth aspect, in combination with the twenty-fourth aspect, determining the at least one normal vector includes determining a low density area in the position data; and determining adjusted position data by applying morphological operations to the low density area in the position data, where the at least one normal vector is determined at least in part based on the adjusted position data.

A twenty-sixth aspect includes a vehicle that includes a memory storing processor-readable code and at least one processor coupled to the memory. The at least one processor may be configured to execute the processor-readable code to cause the at least one processor to perform operations including receiving an image frame depicting an object; receiving position data for the object; determining, based on the position data, a first set of labels for the image frame, where the first set of labels identify where the object contacts a ground surface; determining, based on the position data, a second set of labels, where the second set of labels identify at least one normal vector for the ground surface; and training a machine learning model based on the first set of labels and the second set of labels, where the machine learning model is trained to determine three-dimensional bounding boxes with corresponding contact locations.

In a twenty-seventh aspect, in combination with the twenty-sixth aspect, determining the first set of labels includes determining, based on a bounding box of the object, contact locations where the object contacts the ground surface; determining projected locations of the contact locations within the image frame; and determining locations for the first set of labels based on the projected locations.

In a twenty-eighth aspect, in combination with the twenty-seventh aspect, determining the contact locations includes dividing the bounding box into a plurality of sections; determining, for each respective section of the plurality of sections, a respective lowest position point from the position data located in the respective section; and determining the contact locations based on the respective lowest position points.

In a twenty-ninth aspect, in combination with one or more of the twenty-sixth aspect through the twenty-eighth aspect, determining the second set of labels includes determining at least a subset of the position data corresponding to the ground surface; determining the at least one normal vector based on at least the subset of the position data; and determining the second set of labels based on the at least one normal vector.

In a thirtieth aspect, in combination with the twenty-ninth aspect, determining the at least one normal vector includes determining a low density area in the position data; and determining adjusted position data by applying morphological operations to the low density area in the position data, where the at least one normal vector is determined at least in part based on the adjusted position data.

Components, the functional blocks, and the modules described herein with respect to FIGS. 1-4 include processors, electronics devices, hardware devices, electronics components, logical circuits, memories, software codes, and firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs; that is one or more modules of computer program instructions, encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media, including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc, where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles, and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring such operations to be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for image processing for use in a vehicle assistance system, comprising:
receiving an image frame depicting an object;
receiving position data for the object;
determining, based on the position data, a first set of labels for the image frame, wherein the first set of labels identify where the object contacts a ground surface;
determining, based on the position data, a second set of labels, wherein the second set of labels identify at least one normal vector for the ground surface; and
training a machine learning model based on the first set of labels and the second set of labels, wherein the machine learning model is trained to determine three-dimensional bounding boxes with corresponding contact locations.

2. The method of claim 1, wherein determining the first set of labels comprises:
determining, based on a bounding box of the object, contact locations where the object contacts the ground surface;
determining projected locations of the contact locations within the image frame; and
determining locations for the first set of labels based on the projected locations.

3. The method of claim 2, wherein determining the contact locations comprises:
dividing the bounding box into a plurality of sections;
determining, for each respective section of the plurality of sections, a respective lowest position point from the position data located in the respective section; and
determining the contact locations based on the respective lowest position points.

4. The method of claim 2, wherein the contact locations are determined as position distributions.

5. The method of claim 1, wherein determining the second set of labels comprises:
determining at least a subset of the position data corresponding to the ground surface;
determining the at least one normal vector based on at least the subset of the position data; and
determining the second set of labels based on the at least one normal vector.

6. The method of claim 5, wherein determining the at least one normal vector comprises:
determining a low density area in the position data; and
determining adjusted position data by applying morphological operations to the low density area in the position data,
wherein the at least one normal vector is determined at least in part based on the adjusted position data.

7. The method of claim 1, wherein one or both of the first set of labels and the second set of labels are used to supervise a training process for the machine learning model.

8. The method of claim 7, wherein supervising the training process includes using the first set of labels and the second set of labels in one or more loss functions for the training process.

9. The method of claim 1, wherein the machine learning model is further configured to determine normal maps based on image data.

10. The method of claim 9, wherein the machine learning model is further trained to fuse features from the three-dimensional bounding boxes and the normal maps to determine adjusted bounding boxes for top-down view maps of areas surrounding vehicles.

11. The method of claim 1, further comprising determining, based at least in part on the machine learning model, vehicle control instructions for a vehicle.

12. The method of claim 11, wherein three-dimensional bounding boxes determined by the machine learning model are used to determine the vehicle control instructions.

13. An apparatus, comprising:
a memory storing processor-readable code; and
at least one processor coupled to the memory, the at least one processor configured to execute the processor-readable code to cause the at least one processor to perform operations including:
receiving an image frame depicting an object;
receiving position data for the object;
determining, based on the position data, a first set of labels for the image frame, wherein the first set of labels identify where the object contacts a ground surface;
determining, based on the position data, a second set of labels, wherein the second set of labels identify at least one normal vector for the ground surface; and
training a machine learning model based on the first set of labels and the second set of labels, wherein the machine learning model is trained to determine three-dimensional bounding boxes with corresponding contact locations.

14. The apparatus of claim 13, wherein determining the first set of labels comprises:
determining, based on a bounding box of the object, contact locations where the object contacts the ground surface;
determining projected locations of the contact locations within the image frame; and
determining locations for the first set of labels based on the projected locations.

15. The apparatus of claim 14, wherein determining the contact locations comprises:
dividing the bounding box into a plurality of sections;
determining, for each respective section of the plurality of sections, a respective lowest position point from the position data located in the respective section; and
determining the contact locations based on the respective lowest position points.

16. The apparatus of claim 14, wherein the contact locations are determined as position distributions.

17. The apparatus of claim 13, wherein determining the second set of labels comprises:
determining at least a subset of the position data corresponding to the ground surface;
determining the at least one normal vector based on at least the subset of the position data; and
determining the second set of labels based on the at least one normal vector.

18. The apparatus of claim 17, wherein determining the at least one normal vector comprises:
determining a low density area in the position data; and
determining adjusted position data by applying morphological operations to the low density area in the position data,
wherein the at least one normal vector is determined at least in part based on the adjusted position data.

19. The apparatus of claim 13, wherein one or both of the first set of labels and the second set of labels are used to supervise a training process for the machine learning model.

20. The apparatus of claim 13, wherein the machine learning model is further configured to determine normal maps based on image data.

21. A non-transitory computer-readable medium storing instructions that, when executed by a processor, cause the processor to perform operations comprising:
receiving an image frame depicting an object;
receiving position data for the object;
determining, based on the position data, a first set of labels for the image frame, wherein the first set of labels identify where the object contacts a ground surface;
determining, based on the position data, a second set of labels, wherein the second set of labels identify at least one normal vector for the ground surface; and
training a machine learning model based on the first set of labels and the second set of labels, wherein the machine learning model is trained to determine three-dimensional bounding boxes with corresponding contact locations.

22. The non-transitory computer-readable medium of claim 21, wherein determining the first set of labels comprises:
determining, based on a bounding box of the object, contact locations where the object contacts the ground surface;
determining projected locations of the contact locations within the image frame; and
determining locations for the first set of labels based on the projected locations.

23. The non-transitory computer-readable medium of claim 22, wherein determining the contact locations comprises:
dividing the bounding box into a plurality of sections;
determining, for each respective section of the plurality of sections, a respective lowest position point from the position data located in the respective section; and
determining the contact locations based on the respective lowest position points.

24. The non-transitory computer-readable medium of claim 21, wherein determining the second set of labels comprises:
determining at least a subset of the position data corresponding to the ground surface;
determining the at least one normal vector based on at least the subset of the position data; and
determining the second set of labels based on the at least one normal vector.

25. The non-transitory computer-readable medium of claim 24, wherein determining the at least one normal vector comprises:
determining a low density area in the position data; and
determining adjusted position data by applying morphological operations to the low density area in the position data,
wherein the at least one normal vector is determined at least in part based on the adjusted position data.

26. A vehicle, comprising:
a memory storing processor-readable code; and
at least one processor coupled to the memory, the at least one processor configured to execute the processor-readable code to cause the at least one processor to perform operations including:
receiving an image frame depicting an object;
receiving position data for the object;
determining, based on the position data, a first set of labels for the image frame, wherein the first set of labels identify where the object contacts a ground surface;
determining, based on the position data, a second set of labels, wherein the second set of labels identify at least one normal vector for the ground surface; and
training a machine learning model based on the first set of labels and the second set of labels, wherein the machine learning model is trained to determine three-dimensional bounding boxes with corresponding contact locations.

27. The vehicle of claim 26, wherein determining the first set of labels comprises:
determining, based on a bounding box of the object, contact locations where the object contacts the ground surface;
determining projected locations of the contact locations within the image frame; and
determining locations for the first set of labels based on the projected locations.

28. The vehicle of claim 27, wherein determining the contact locations comprises:
dividing the bounding box into a plurality of sections;
determining, for each respective section of the plurality of sections, a respective lowest position point from the position data located in the respective section; and
determining the contact locations based on the respective lowest position points.

29. The vehicle of claim 26, wherein determining the second set of labels comprises:
determining at least a subset of the position data corresponding to the ground surface;
determining the at least one normal vector based on at least the subset of the position data; and
determining the second set of labels based on the at least one normal vector.

30. The vehicle of claim 29, wherein determining the at least one normal vector comprises:
determining a low density area in the position data; and
determining adjusted position data by applying morphological operations to the low density area in the position data,
wherein the at least one normal vector is determined at least in part based on the adjusted position data.
